(19) United States
(12) Patent Application Publication
(10) Pub. No.: US 2003/0083019 A1
(43) Pub. Date: May 1, 2003

(54) Lightweight mobile station

(76) Inventors: John Patrick Wong, Vancouver (CA); Dean Parfeniuk, Anmore (CA); Tony Mark, Vancouver (CA)

Correspondence Address: SCHEEF & STONE, L.L.P., 5956 SHERRY LANE, SUITE 1400, DALLAS, TX, 75225, US

(21) Appl. No.: 09/999,365

(22) Filed: Oct. 31, 2001

(51) Int. Cl. H04B 1/38

(52) U.S. Cl. 455/90; 455/566; 379/433.04

(57) ABSTRACT

An improved, battery-operated liquid-crystal display (LCD) device designed to use the battery as a structural support for the LCD. The device, typically a cellular phone, media phone, or other telecommunications mobile station, includes a housing that encloses station components. The housing forms a window through which the LCD screen may be viewed when the device is in operation. A recess behind the LCD is formed for receiving a battery. The battery is made of a material that is sufficiently resistant to bending that, when the device, including the battery, is assembled, the battery structurally engages the LCD. That is, the battery provides at least some structural support to the LCD so as to reduce or eliminate deformation of the LCD that would otherwise have occurred due to a stress applied to the device.

The present invention relates generally to the field of wireless mobile stations, and more specifically to an improved design for a mobile station that reduces the likelihood of mishandling-related damage to the liquid-crystal display (LCD).

### BACKGROUND OF THE INVENTION

Telephone were, for many years, not mobile at all. Instead, they were connected by a series of wires and cables to the local exchange (sometimes referred to as a switching office), and from there to the rest of the network itself. In this configuration, one or more lines were connected to a subscriber's residence or business location, usually entering the building and connecting just inside at a terminal block, that is, a central location where connections could be made to the telephone devices located within the building itself. The actual telephone, that is, the instrument by which the subscriber sent and received communications, was connected to the terminal block by a wire running through the building. The telephone itself typically featured a relatively large housing in which the electrical components necessary for engaging in telephone communications were enclosed. A microphone was provided for picking up the subscriber's voice and converting it into electrical signals for transmission, and was frequently enclosed in its own housing. The microphone housing formed an open-ended cavity into which the subscriber could speak, with the microphone being located at the end of the cavity opposite the open end. The microphone housing was either attached to the main telephone housing or held as a separate unit by the subscriber, but in either case, the microphone itself was connected to the telephone circuitry enclosed in the telephone housing via a cable or wire (the terms herein being used synonymously unless otherwise specified). The subscriber would hear the conversation on a speaker, also enclosed in its own housing, which was, in turn, generally connected by a cord of some length to the telephone housing itself.

In later model telephones, a personal telephone handset was often employed. The handset featured a microphone and a speaker in one housing, suitably mounted in a spaced-apart relationship so that the speaker could be held to the ear while the microphone was positioned near the mouth. The handset housing comprised an elongated member that provided seats for mounting the microphone and speaker, and also included a handle portion for the subscriber to hold onto while using the handset. The handset was connected to the main telephone body by a cord containing wires for carrying signals (and power, which ultimately was supplied from a source at the local exchange) to and from the speaker and microphone. In use, the body of the telephone was often mounted to a wall or connected to a wall receptacle by a short cord, while the handset might be connected to the main telephone body by a somewhat longer cord. The length of the handset cord defined the limit of the user's “mobility”. The telephone housing or main body included a switch hook on which the handset rested when not in use. The weight of the handset moved the switch to open the circuit. The switch was spring-loaded to return to a position closing the circuit when the handset was lifted by a subscriber wishing to make a phone call. Closing the circuit connected the telephone to the local exchange, and signaled to the telephone company that the subscriber was ready to make a telephone call.

Eventually, a sort of greater mobility was achieved as homes and businesses came to have more than one or even many telephones, any one of which could be used to connect the subscriber to the local office from different locations. To avoid the need to purchase too many appliances, wall-mounted receptacles were designed that could receive quick-connect jacks attached to a phone cord. This meant that a single instrument could be moved to any location where such a receptacle was located and simply plugged in for operation. Mobility was still limited, however, to the location currently in use, and of course, installing receptacles too far from the terminal block was impracticable.

The mobility of phones changed dramatically with the advent of wireless networks. In a wireless network, the mobile telephone handset allows the subscriber to move throughout the network-coverage area. This mobility is possible by an array of geographically-distributed base-station systems (BSSs) that communicate with nearby mobile phones using wireless radio frequency (RF) communication. The BSSs relay signals received from the mobile telephones to the rest of the network. The network, in this case, is usually referred to as a public land mobile network (PLMN) although it may connect through gateways with the public switched telephone network (PSTN) or other communications networks such as the Internet. Ideally, a mobile telephone is, while in the network-coverage area, within communication range of two or more BSSs, but actively communicating with only one. When the mobile phone moves from one place to another, the active communication link switches from one BSS to another in a process referred to as “handoff”. As a result, the subscriber may place a telephone call from almost any location provided it is within range of a BSS, and not too close to any obstacle or device that might interfere with radio communications.

In addition to mobile telephones, other devices have been developed that are also able to utilize the wireless (radio) telecommunications network. For example, a wireless paging device may be suited for receiving a signal including a telephone number to call or a short message, the pager enunciating or otherwise alerting the subscriber when such a transmission has been received. More recently, two-way pagers have been developed as well, allowing the subscriber to send replies or return messages. Wireless personal digital assistants (PDAs) have also evolved so as to be able to communicate effectively through a wireless network. A PDA is, in general, an electronic device that acts as a personal organizer, typically storing an address book, appointment calendar, and other similar information. A PDA that is connected to a wireless network is able to exchange this information with, for example, a central server or other device to either provide a backup or to coordinate information between multiple subscribers. Electronic devices for communicating with an Internet service provider (ISP) in order to connect with the Internet to, for example, send email or search the World Wide Web (“Web”). Often called “Web-phones”, “Web-enabled phones”, or simply “media phones”, these devices are, as their name implies, typically integrated with a wireless telephone, but can be used for Internet access as well. In addition, there are other wireless devices that combine the functions described above or, alternately, perform only certain selected functions. For convenience, all of these (and similar) devices will be herein referred to as “mobile stations”.

Mobile stations were originally themselves quite bulky devices. At the time they became popular, communications technology had evolved to the point where the telephone circuitry was not so space-consuming that it could be entirely enclosed in a handset-like device. They received no electrical power from a central telephone company source, however, and therefore either had to be connected to either an electrical outlet (via an adaptor) or a battery. The batteries, especially, were large and bulky. Mobile stations in automobiles, of course, could simply use the automobile's electrical system for power, but truly mobile phones, those carried from place to place by subscribers, often required a separate carrying-case containing a rather large battery. Eventually, however, the batteries themselves also became small enough to be conveniently integrated into the design of the telephone handset and the whole mobile station could be carried around as a single unit. In modern mobile stations, the battery often attaches to the device itself at a location where no controls are otherwise located (see for example FIG. 1). Contacts on the battery exterior engage contacts on the housing of the mobile station and the battery is fixed into position in some way. The telephone housing frequently has a recess into which the battery can be fitted and a means by which it can be secured. The assembled unit appears as a single handset unit upon casual inspection.

In addition to a speaker and microphone, mobile stations will generally include a keypad, one either fashioned as an ordinary telephone keypad, or, alternately, based on a modified computer-keyboard design. The keyboard allows the subscriber to input information such as the number to be called or the text of a message to be transmitted. Some form of visual display is often present, as well, providing a user interface upon which the user can view the input keyboard sequences or the text of a received message. Displays are especially useful in mobile phones for a couple of reasons. First, a “mobile” subscriber is often otherwise occupied driving for example, or crossing the street. Not being able to devote full attention to dialing in the normal fashion, having the number displayed allows the dialer to confirm that the correct number has been entered. Displaying the number or identity of an incoming caller is also desirable, especially when billing is based on airtime. When the called party realizes that an incoming call may be unnecessary, it is simply not answered and the associated charges are avoided. The display may also indicate system, signal, and call status, useful information in the mobile environment. And with web-enabled media phones, all manner of graphics are available for display. The display screen is an indispensable feature of a modern mobile station.

Frequently, the display used in mobile stations is a liquid crystal display (LCD). LCDs are frequently used because of their versatile capabilities and relatively low power consumption. In general, LCDs are composed of a liquid-crystal layer sandwiched between transparent, light-polarizing materials along with electrical conductors and electrodes that enable a bias voltage to be applied across a specific small area (that is, a pixel) of the liquid-crystal layer. Applying the voltage difference to the pixel electrode alters the light-polarizing characteristics of the liquid crystal material proximate to the electrode. Light waves that are polarized when passing through one polarizing layer will typically not pass through the other, cross-polarized layer, unless the phase angle of the polarized light is changed as it passes through the liquid-crystal layer between them. Liquid crystals are substances that flow like liquids, but whose molecules nevertheless maintain a definite orientation with respect to each other. This orientation may be changed from one that causes the needed phase-angle change to one that does not through the application of an electrical charge, as described above. The liquid-crystal orientation, therefore, determines whether the pixel will appear light or dark. Color LCDs include color-filtering subpixels in each pixel so that the wavelength of the passing light can be controlled and color images produced. An LCD for media phone use may have hundreds of such pixels, and very satisfactory images can be displayed upon it.

Unfortunately, the LCD is also a somewhat fragile device. Although frequently protected by a sturdy plastic cover over its outer face, to avoid being punctured, it is also subject to damage that is caused by being twisted or deformed. This twisting or other deformation may be induced when the mobile station undergoes unintended strain. For example, the subscriber may store the mobile station in a briefcase which may then be stuffed with a number of books or other heavy objects, causing the mobile station to undergo a small, but detrimental, amount of deformation. Mobile stations stored in the pockets of jackets or purses may experience similar problems when the jacket or purse is thrown into the back seat of a car or something is set on top of it. Even dropping the mobile station may result in temporary deformation upon impact. Whatever the cause, however, in a great many cases, the mobile station's sturdy plastic housing will be resilient enough to undergo only elastic deformation, and often exhibit no physical signs of damage. Some of the stress and resulting deformation, however, may be transferred to the LCD with a less favorable outcome. The various components of the LCD, described above, often lack the strength and resiliency of the rest of the components of the mobile station. Even a slight deformation of the LCD may result in local cracking of the various layers or even local separation. If this happens the entire LCD may be rendered totally inoperative, or there may be certain areas on it where activation of the liquid crystal is no longer possible. This may result in permanently light or dark spots in undesirable locations.

To guard against such damage, the LCD is placed within a metal chassis. The chassis preferably has the strength and resistance to deformation necessary to avoid mishandling damage occurring to the LCD, or the chassis may simply absorb the deformation itself, being constructed so as to allow the LCD to remain undeformed even when the chassis is not in its original shape. Although fairly effective at preventing mishandling damage to the LCD, however, the metal chassis nevertheless represents somewhat of a retreat in mobile station design because of the mass and bulk it adds to the mobile station. There is simply no way to construct a chassis having the favorable characteristics described above without having it, at the same time, take up an inordinately large amount of space and contributing unduly to the weight of the mobile station.

Needed, therefore, is a way to reduce or prevent mishandling damage to the LCD of a mobile station without adding undue weight or size to the instrument. The present invention provides just such a solution.

### SUMMARY OF THE INVENTION

To overcome the deficiencies in the prior art described above, the present invention provides an improved design for mobile phone handsets. The instrument of the present invention preferably includes a first housing portion and a second housing portion, although in some embodiments there may be less or more than two. The first housing portion and second housing portion, when assembled, enclose transceiver circuitry sufficient for phone operation, and a liquid-crystal display (LCD) for providing a visual user interface. The assembled housing further enclosed a battery element for providing electrical power for use by telephone components, the battery element being made of a substantially stiff material and, when the first housing portion and the second housing portion are assembled in an operating configuration, is disposed in a fixed position with respect to the LCD such that it provides resistance to LCD deformation. The battery may be affixed to the first housing portion in such a way as to secure it and the LCD in position, or it may be held in place by affixing the second housing portion to the first housing portion. In another aspect, the invention is a battery-powered LCD device formed to receive a battery that structurally engages the LCD.

A more complete appreciation of the present invention and the scope thereof can be obtained from the accompanying drawings that are briefly summarized below, the following detailed description of the presently-preferred embodiments of the present invention, and the appended claims.

### BRIEF DESCRIPTION OF THE DRAWINGS

For a more complete understanding of the present invention, and the advantages thereof, reference is made to the following drawings in the detailed description below:

FIG. 1A is an illustration depicting a conventional mobile telephone of the prior art as viewed from the front;

FIG. 1B is an illustration depicting the mobile telephone shown in FIG. 1 as it appears when viewed from the side;

FIG. 2 is a partially cutaway side view of the telephone illustrated in FIGS. 1A and 1B, taken along line A-A of FIG. 1A;

FIG. 3 is an illustration depicting a typical media phone of the prior art;

FIG. 4 is a perspective view (exploded) illustrating a mobile station according to an embodiment of the present invention;

FIG. 5 is a perspective view (exploded) of a mobile station, illustrated in accordance with another embodiment of the present invention;

FIG. 6 is a perspective view (exploded) of a mobile station 600 illustrated in accordance with yet another embodiment of the present invention; and

FIG. 7 is a perspective view of mobile station 700 (exploded) constructed according to yet another embodiment of the present invention.

### DETAILED DESCRIPTION

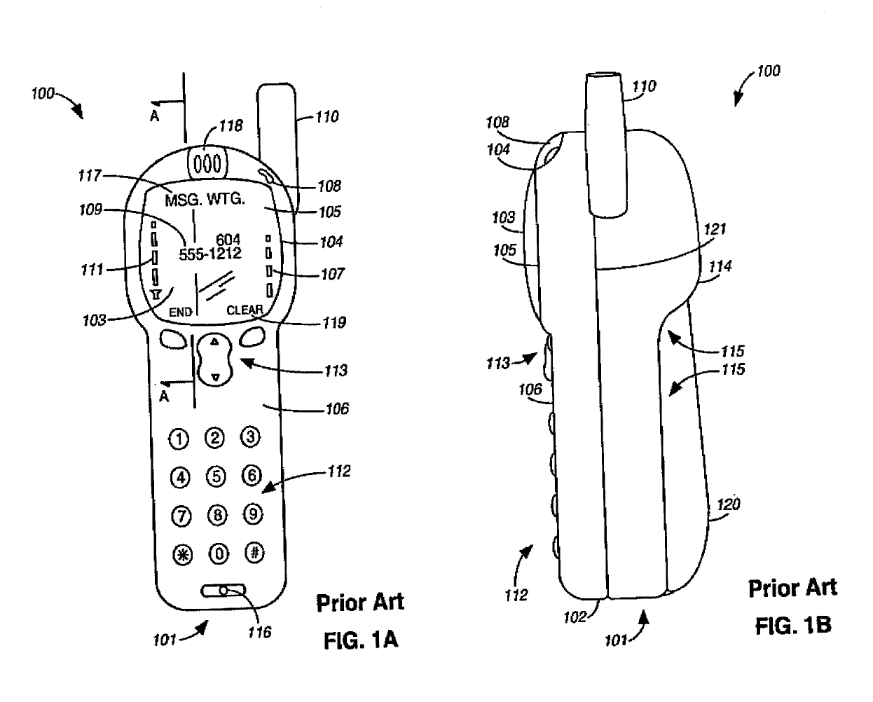

FIGS. 1A, 1B, and 2 through 7, discussed below, and the various embodiments used to describe the present invention are by way of illustration only, and should not be construed to limit the scope of the invention. Those skilled in the art will understand the principles of the present invention may be implemented in any suitable LCD device, in addition to the devices specifically discussed herein.

FIG. 1A is an illustration depicting a conventional mobile telephone 100 of the prior art as viewed from the front. Mobile telephone 100 includes housing 101 having a face 106 that is the side or portion of the telephone on which most user-accessible controls are located. For example, telephone 100 includes a numeric keypad 112, and on/off button 108, and auxiliary control buttons 113. Face 106 of housing 101 includes a window 104 through which LCD 105 is visible when the telephone 100 is assembled. LCD 105 provides the visual user interface of telephone 100, as described in more detail above. In the embodiment of FIG. 1, LCD 105 may display a variety of information including called telephone number 109, battery status indicator 107, signal strength indicator 111, and message waiting indicator 117. Auxiliary buttons 113 are frequently multi-function buttons, with the current function of each of the buttons being displayed upon LCD 105 in the area generally designated by reference number 119. The function of each of the auxiliary buttons 113 frequently changes with the specific operation being performed by the subscriber, and so it is extremely convenient to have the functions displayed. Telephone 100 also quite naturally includes a microphone port 116 and speaker ports 118. Note that both microphone 116 and speaker 118 are actually internal components, but receive and project sound through the associated speaker ports formed in housing 101. An antenna 110 is used to assist in the transmission and reception of radio signals.

FIG. 1B is an illustration depicting the mobile telephone 100 shown in FIG. 1 as it appears when viewed from the side. Keypad 112, auxiliary buttons 113 and on/off buttons 108 are in this view visible, as is antenna 110. From this perspective, it can also be seen that housing 101 comprises front housing portion 102, and back housing portion 114. Typically, the two separate housing portions of telephone 100 are joined together to enclose the various telephone components. While the basic housing 101, that is, the enclosure for the telephone circuitry, may include more than two separable portions, it is preferable to have only two. These housing portions joined at parting line 121, are held together by a fastening means (not shown) when the phone is assembled. Back housing portion 114 forms a recess 115 for receiving an appropriately-shaped battery 120. As described above, battery 120 includes positive and negative contacts that engage corresponding contacts on the surface of back housing portion 104 (the contacts not being shown in FIG. 1B). The battery is removably attached to back housing portion 104 so that it may be installed and removed conveniently.

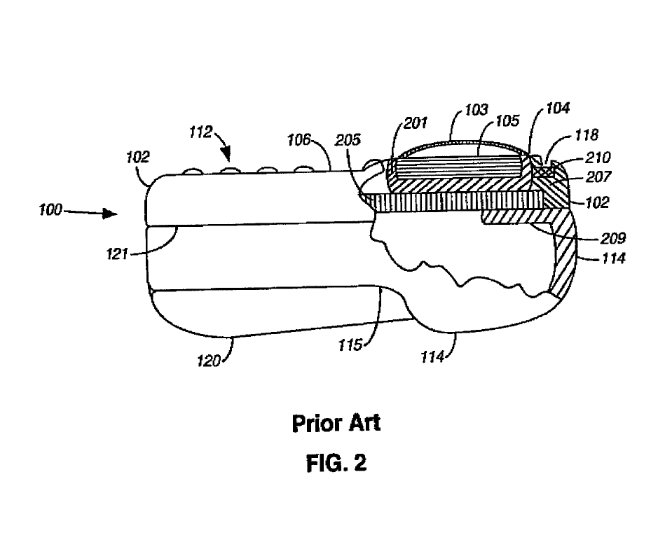

FIG. 2 is a partially cutaway side view of the telephone 100 illustrated in FIGS. 1A and 1B, taken along line A-A of FIG. 1A. Keys 112 protruding through face 106 of front housing 102, parting 121, and battery 120 fitted into recess 115 of back housing 114 are shown for reference. Also shown in this view is speaker element 210 situated behind speaker port 118. Printed circuit board (PCB), on which much of the telephone 100 circuitry and electronic components (not shown) are mounted, is held in place by supports 207 and 209, extending inwardly from front housing 102 and back housing 115, respectively. LCD 105, visible through window 104 in front housing 102, is disposed behind protective cover 103. As can be seen in FIG. 2, LCD 105, except for its visible face, is completely disposed securely within chassis 201. Chassis 201 is, in turn, preferably secured to PCB 205. As mentioned previously, chassis 201 is preferably constructed of a sturdy metal alloy and of sufficient dimension so as to prevent bending or twisting deformation of LCD 105, even when under stress. To meet these criteria, however, chassis 201 takes up a relatively large amount of space and adds to the weight of the mobile station. Eliminating the need for chassis 201 by modifying the design of telephone 100 is the gist of the present invention.

Although the telephone 101 depicted in FIGS. 1A, 1B, and 2 above are currently in widespread use, alternative types of mobile stations are also becoming popular. Some of these, such as media phone 300 described below, have a much larger LCD screen than telephone 101 and thus will derive an even greater benefit from the novel design of the present invention.

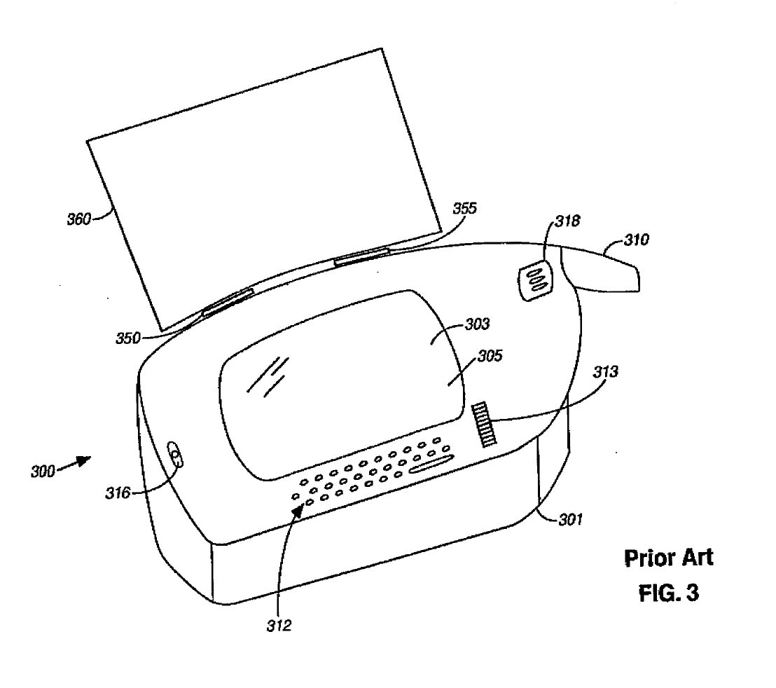

FIG. 3 is an illustration depicting a typical media phone 300 of the prior art. Media phone 300, like its precursor the cellular telephone, features a keypad 312. Keypad 312, however, contains a great many more keys for ease in entering alpha-numeric input, which given the shape and layout of media phone 300, is often performed by the user with their thumbs. Thumbwheel 313 can be used for scrolling through information that is being displayed. As can be seen in FIG. 3, the LCD 305 of the media phone 300 is relatively much larger than the one used in a conventional telephone, such as telephone 100 shown in FIG. 1. As a result, the LCD is able to display not only a greater quantity of text than could previously be viewed, but also a wider variety of graphical images and other visual information. As media phone 300 is intended for use in retrieving and displaying Web pages and the like, this additional display space is practically a necessity. Media phone 300 also includes on/off button 308 and antenna 310. Microphone port 316 and speaker ports 318 are spatially separated such that the media phone 300 may also be used as a standard telephone for conversation. Media phone 300 includes housing 301 to which are attached hinges 350 and 355 allowing cover 360 to be moved from a closed position (not shown) where it protects the LCD 305 and keypad 312, to an open position where it typically remains while the media phone is in use. Note that when the media phone 300 is used for a standard telephone conversation, the protective cover 360 can be closed protectively while still leaving exposed microphone port 316 and speaker ports 318. In an alternate embodiment, the protective cover protects only the LCD 305 and leaves keypad 312 exposed for use during the telephone call. Naturally, media phone 300 is also powered by a battery (not shown), which typically attaches in a manner similar to that used for attaching the battery 120 to telephone 100 (as shown in FIG. 2. As with telephone 100, the visible face of LCD 305 of media phone 300 is protected by a clear plastic cover 303. The remainder of LCD 305 is securely disposed within a substantial chassis (not shown in FIG. 3) to protect it from bending and twisting deformation.

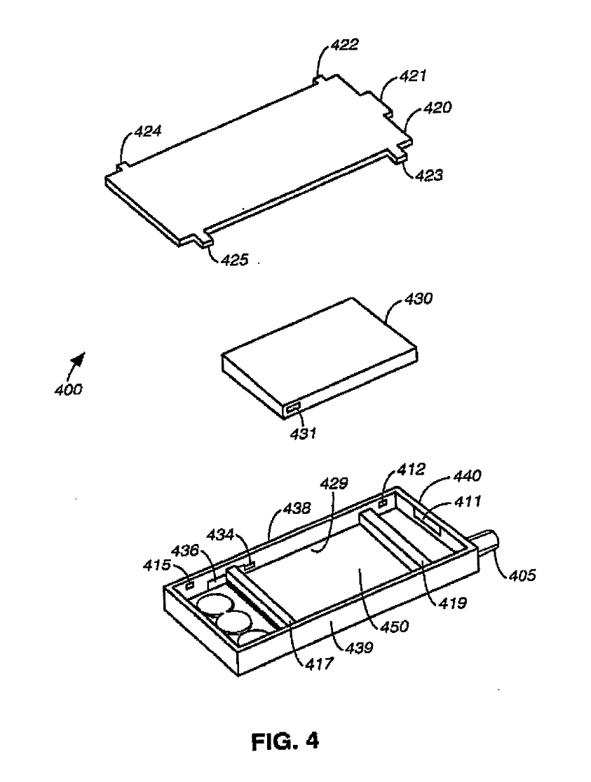

FIG. 4 is a perspective view (exploded) illustrating a mobile station 400 according to an embodiment of the present invention. Note that the device illustrated in FIG. 4 is drawn generically and is referred to as a mobile station because the improved design of the present invention may be adapted for use with each of the more familiar looking devices of FIGS. 1-3 and with numerous other devices, as well. Mobile station 400 includes front housing 410 and back housing 420, which when assembled enclose all the internal components of mobile station 400. Note that for clarity, many of the internal components of mobile station 400 have been omitted in FIG. 4, except as necessary to show the relationship of certain components in accordance with the present invention. Shown in FIG. 4, however, is LCD 450 in place such that it is visible through the LCD window (not shown) of front housing 410. Disposed immediately behind LCD 450 are restraining devices 417 and 419. Restraining devices 417 and 419 act to hold LCD 450 in place even in the unassembled condition suggested in FIG. 4. Although shown as largely rectangular in shape and substantial in size, there is no requirement for their size and shape beyond their ability to perform this function. And, although in this embodiment there are two such restraining devices, depending on the design of mobile station 400, there may be only one or more than two.

Preferably, restraining devices 417 and 419 are configured to remain stationary within front housing 410 even when the mobile station 400 is disassembled. This may be accomplished in a number of different ways. For example, in the illustrated embodiment, restraining devices 417 and 419 extend laterally across the interior of front housing portion 410 from sidewall 438 to sidewall 439. Restraining devices 417 and 419 are simply pressed into place, with the pressure of the sidewalls then preventing their easy movement. Optionally, one or more tabs (not shown) could extend inwardly from sidewall 438 (and likewise sidewall 439) at the expected location of restraining devices 417 and 419 in order to ensure that they do not slip out inadvertently. In another embodiment, a fastener is used such as a threaded fastener that is, for example, entered through an opening in sidewall 439 and threaded into restraining device 417 in a threaded opening placed proximate to the opening in sidewall 439. Other methods may be used as well. In general, restraining devices 417 and 419, as well as the apparatus used to hold them in place, will be designed to minimize the amount of extra space required and the weight burden that they add to the device itself. In another embodiment (not shown), restraining devices 417 and 419 are simply small, flexible or spring-loaded rods or similar devices that can be inserted into place in impressions formed in appropriate locations on the interior wall of sidewall 438 and sidewall 439. They may also be ribbons or cords. Returning to the embodiment of FIG. 4, restraining devices 417 and 419 also act along with sidewalls 438 and 439 to form a cavity 429 into which battery 430 may be inserted. Battery 430 includes a pair of electrical contacts, one of which, contact 431, is visible in the view of FIG. 4. Electrical contact 431 and its counterpart on the opposite side of battery 430 engage the corresponding electrical contacts located on the interior of sidewall members 438 and 439 of housing 410 when the battery is placed in cavity 429. (Again, in this view, only one contact, contact 434, is visible.) Note that in the illustrated embodiment, restraining devices 417 and 419 will also help to hold battery 430 in place when the mobile station 400 is assembled, a feature that is preferable, but not required.

Battery 430 is, for example, a nickel cadmium (NiCa) battery, but is enclosed in a stiff outer shell in order to structurally engage LCD 450 in accordance with an embodiment of the present invention. Materials of this type suitable for housing battery 430 are well known in the relevant art. As used herein, the term “structurally engage” connotes a relationship whereby a component, in this case LCD 450, is not only held substantially fixed in one location, but also supported along a substantial extent of its surface area. Note that in addition to being composed of a relatively stiff material, battery 430 is of a size and shape to substantially engage much but not necessarily all of the back side of LCD 450. The structural engagement of LCD 450 by battery 430 helps to prevent, and preferably eliminate, bending and twisting deformation. Note that for this effect to occur, LCD 450 and battery 430 do not have to be co-terminus on their adjacent sides, nor do they have to be the same size or shape. In addition, they do not have to be in direct contact. In other words, it is generally preferred, though not required, that battery 430 actually come into contact with LCD 450 when the mobile station 400 is assembled, so long as any intervening materials do not substantially detract from the structural support offered to the LCD 450 by the relatively stiff battery 430. For example, in a preferred embodiment, the outer surface of battery 430 is compatible with contacting directly the rear side of LCD 450. In an alternate embodiment, however, there may be a need to provide a non-conductive or non-abrasive intermediate layer (not shown) between the two components. This intermediate layer (or layers) does not detract from the “structural engagement” relationship between battery 430 and LCD 450 so long as they are properly constructed and fitted. If, on the other hand, an intermediary layer between the two components was simply a relatively fixed sponge-like material, battery 430 would provide little structural support to LCD 450. In accordance with describing and claiming the present invention, therefore, structurally engaging will be construed as meaning that a stiffening element (such as battery 430) provides significant (that is, non-negligible) resistance to deformation of the LCD 450.

Returning to the embodiment of FIG. 4, once battery 430 has been placed in cavity 429, back housing 420 can be installed. In the illustrated embodiment, tab 421 is inserted into slot 411 and then the four tabs on the exterior of back housing 420 are press-fit into corresponding indentations on the interior of the sidewalls 438 and 439 of front housing member 410 (in the illustrated embodiments, indentations 412 and 414 are shown). “Press-fit” simply indicates that the tabs are forced into the indentations, or are forced out during the removal process by slightly flexing back housing member 420. Once in place, back member 420 holds battery 430 in place against LCD 450. Note that the method for attaching back housing 420 is for purposes of illustration only, and other means are possible. For example, in an alternate embodiment (not shown), back housing 420 includes tab 421 for insertion into slot 411 formed in top side 440 of housing 410, but the side tabs 422-425 on back housing 420 are not present. Instead, sidewalls 438 and 439 of front housing 410 each form a groove on their interior wall extending substantially the length of the wall and terminating at the interior side of top side 440. When assembled, battery 430 is placed in cavity 429 as before, but back housing 420 is then installed by sliding it through the grooves in sidewalls until tab 421 has entered slot 411. In this alternate embodiment, a retaining member may also be added to prevent back housing 420 from inadvertently sliding out of its closed position. This alternate embodiment is advantageous because back housing member 420 can be made of a substantially stiffer material because it need not flex during installation. This provides additional support for battery 430, holding it in place and increasing its structural-support capability with respect to LCD 450.

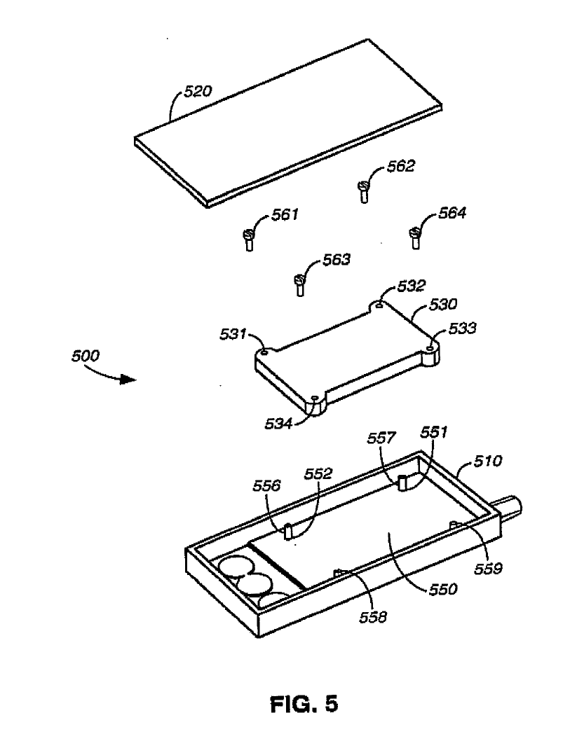

FIG. 5 is a perspective view (exploded) of a mobile station 500, illustrated in accordance with another embodiment of the present invention. The mobile station 500 of FIG. 5 is in many respects similar to mobile station 400 (shown in FIG. 4) and analogous components are similarly numbered. In the embodiment of FIG. 5, LCD 550 forms openings 551 and 552 through which fastener-receiving cylinders 556 and 557 protrude. (In this view, a portion of fastener-receiving cylinders 558 and 559 are also visible.) Fastener-receiving cylinders 556-559 are preferably securely fixed to, or integrally formed with, front housing 510. In an alternate embodiment (not shown), the fastener-receiving cylinders protrude from front housing 510, but do not pass through LCD 550. Battery 530 forms fastener openings 531, 532, 533, and 534, for receiving fasteners 561, 562, 563 and 564, respectively. Note that in FIG. 5, the battery is said to be “fastenable” to front housing 510, a term that encompasses being fastened indirectly as well as directly, and by any type of suitable fastening device. When battery 530 is positioned, it is secured in place with the fasteners to prevent movement and contribute to battery 530's ability to structurally engage LCD 550. Although no mechanism is shown in FIG. 5 for attaching back housing 520 to front housing 510 during telephone assembly, any suitable method may be used. One distinction between the embodiment of FIG. 5 and the above-described embodiment of FIG. 4 is then the fact that back housing member 520 makes little or no contribution to holding battery 530 in place once the phone is assembled. This may provide for design flexibility, which in many cases may be desirable.

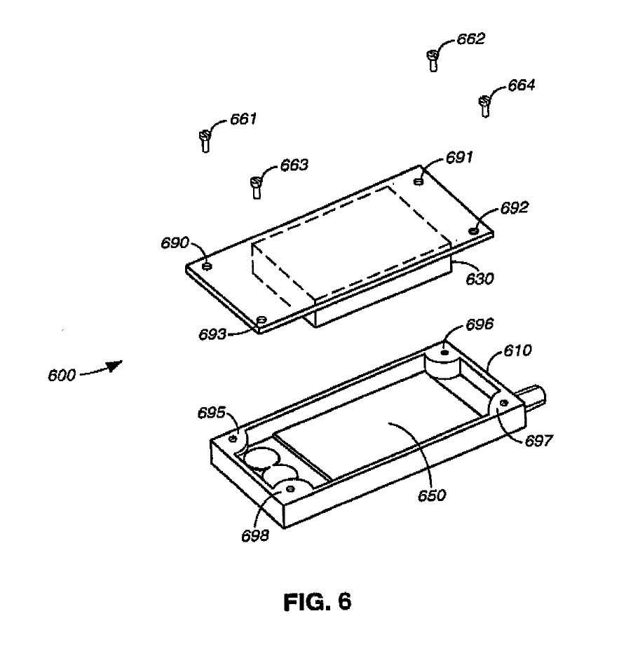

FIG. 6 is a perspective view (exploded) of a mobile station 600 illustrated in accordance with yet another embodiment of the present invention. In this embodiment, battery 630 is integrally formed to function not only as the battery, but as a back cover for the housing of a mobile station. Being made of very stiff material, battery 600 substantially structurally engages LCD 650 to provide structural support in accordance with the present invention. In the embodiment of FIG. 6, battery 600 forms openings 690, 691, 692, and 693 through which, when battery 600 is fitted onto housing 610, fasteners 661, 662, 663, and 664 are passed in order to threadedly engage comer supports 695, 696, 697 and 698, respectively.

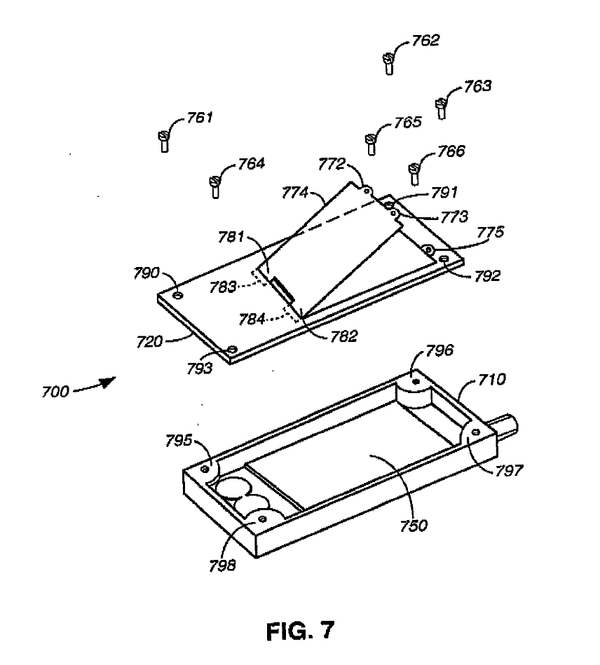

FIG. 7 is a perspective view of mobile station 700 (exploded) constructed according to yet another embodiment of the present invention. LCD 750 is shown in place in front housing 710. The remaining internal components of mobile station 700 have been omitted for clarity. When assembled, back housing 720 is fitted onto front housing 710 such that fastener openings 790, 791, 792, and 793 are axially aligned with threaded openings of comer members 795, 796, 797 and 798, respectively, so that threaded fasteners 761, 762, 763, and 764 may be used to secure back housing 720 to front housing 710. Back housing 720 forms a window 770 that is large enough for a battery (not shown) to pass through into position in front housing 710. Door 774 is then secured to back housing 720 by positioning tabs 781 and 782 of door 774 in corresponding recesses 783 and 784, then pivoting door 774 until it engages back housing 720. when closed, tabs 772 and 773 on door 774 are received into recesses in back housing 720 (recess 775, which receives tab 773, is visible in FIG. 7) such that their respective fastener openings align. Door 774 is then secured into position with door fasteners 765 and 766. Once door 774 is secured in place, of course, the battery is held properly in position, structurally engaging LCD 750.

The preferred descriptions are of preferred examples for implementing the invention, and the scope of the invention should not necessarily be limited by this description. The scope of the present invention is defined by the following claims.

What is claimed is:

1. A mobile station, comprising:
a first housing member;
a liquid-crystal display (LCD);
a battery;
wherein the LCD is captured between the battery and the first housing member such that the battery structurally engages the LCD.

2. The mobile station of claim 1, further comprising a window in the first housing member through which the LCD may be viewed when the telephone is in operation.

3. The mobile station of claim 2, further comprising a retaining element between the LCD and the first housing member.

4. The mobile station of claim 1, wherein the battery is fastenable to the first housing member.

5. The mobile station of claim 4, further comprising at least one fastener for fastening the battery to the first housing portion.

6. The mobile station of claim 5, wherein the at least one fastener comprises a plurality of fasteners.

7. The mobile station of claim 1, further comprising a second housing member.

8. The mobile station of claim 7, wherein the battery is captured between the second housing portion on one side and between the LCD and the first housing portion on the other.

9. The mobile telephone of claim 7, further comprising at least one fastener for fastening the battery to the second housing member.

10. The mobile telephone of claim 9, wherein the at least one fastener comprises a plurality of fasteners.

11. An improved LCD device using a battery as a support element, said LCD device comprising:
an LCD;
a first housing portion forming a window through which the LCD is visible; and
a battery, wherein the battery is for capturing the LCD between the battery and the first housing portion when the LCD device is assembled.

12. The LCD device of claim 11 further comprising a retaining element positioned adjacent the LCD.

13. The LCD device of claim 12, further comprising at least one fastener for securing the battery to the first housing portion.

14. The LCD device of claim 13, further comprising a second housing portion.

15. The LCD device of claim 14, further comprising at least one fastener for fastening the battery to the second housing portion.

16. The LCD device of claim 14, where in the second housing portion is for capturing the battery when the LCD device is assembled.

17. The LCD device of claim I 1, wherein the battery forms an opening therethrough to receive a fastener.

18. The LCD device of claim 17, further comprising a plurality of fastener openings.

19. A battery-powered communications device for use in communicating through a communications network, said communications device comprising:
an LCD;
a housing forming a window through which the LCD may be viewed when the communications device is being used, said housing forming a battery recess for receiving a battery, the battery for structurally engaging the LCD.
